(19) United States
(12) Patent Application Publication
(10) Pub. No.: US 2026/0155951 A1
(43) Pub. Date: Jun. 4, 2026

(54) INFORMATION PROCESSING DEVICE, INFORMATION PROCESSING SYSTEM, AND INFORMATION PROCESSING METHOD

(71) Applicant: DENSO CORPORATION, Kariya-city (JP)

(72) Inventors: Tatsuya OKABE, Kariya-city (JP); Haruhiko NAMIKI, Kariya-city (JP); Taro NAKASENDO, Tokyo (JP); Yasunobu NOBUKI, Tokyo (JP); Marito KAKINOKI, Tokyo (JP); Keita HIBARI, Tokyo (JP)

(21) Appl. No.: 19/461,309

(22) Filed: Jan. 27, 2026

Related U.S. Application Data
(63) Continuation of application No. PCT/JP2024/017189, filed on May 9, 2024.

(30) Foreign Application Priority Data
Jul. 31, 2023 (JP) 2023-125000

(51) Int. Cl. H04L 9/00; H04L 9/08; H04L 9/30

(52) U.S. Cl. CPC H04L 9/008; H04L 9/0894; H04L 9/3006

(57) ABSTRACT

An information processing device that manages item-related information related to an item includes a database that stores each of a plurality of sets of a private key and a public key in association with a key name and is configured to: acquire, from a transactor terminal of the transactor, encrypted information obtained by encrypting item-related information by using a public key and a key name of the public key used to encrypt the item-related information; acquire, from the database, a private key corresponding to the key name; acquire decrypted information by decrypting, with the private key, the encrypted information; acquire re-encrypted information by encrypting the decrypted information; and provide the re-encrypted information encrypted by the encryption processing section to the transactor terminal.

### CROSS REFERENCE TO RELATED APPLICATION

The present application is a continuation application of International Patent Application No. PCT/JP2024/017189 filed on May 9, 2024 which designated the U.S. and claims the benefit of priority from Japanese Patent Application No. 2023-125000 filed on Jul. 31, 2023. The entire disclosures of all of the above applications are incorporated herein by reference.

### TECHNICAL FIELD

The disclosure according to this specification relates to an information processing device.

### BACKGROUND

A related art discloses a supply chain management method for managing a transaction record between transactors in a supply chain constructed including a plurality of transactors.

Another related art discloses an encryption system capable of performing a homomorphic operation on encrypted data encrypted with a user public key and decrypting an operation result of the homomorphic operation by using a master private key.

### SUMMARY

According to an aspect of the present disclosure, an information processing device that manages item-related information related to an item handled by a plurality of transactors that constitutes a supply chain is provided. The information processing device includes a database that stores each of a plurality of sets of a private key based on homomorphic encryption and a public key corresponding to the private key in association with a key name, and at least one of (i) a circuit and (ii) a processor with a memory storing computer program code executable by the processor, the at least one of the circuit and the processor configured to cause the information processing device to: acquire, from a transactor terminal of the transactor, encrypted information obtained by encrypting item-related information by using a public key, and a key name of the public key used to encrypt the item-related information; acquire, from the database, a private key corresponding to the key name; acquire decrypted information by decrypting, with the private key, the encrypted information; acquire re-encrypted information by encrypting the decrypted information; and provide the re-encrypted information encrypted to the transactor terminal. The at least one of the circuit and the processor may be further configured to acquire, from the transactor terminal of the transactor, encrypted information encrypted by using a public key that is a public key based on homomorphic encryption and is a public key different from a public key managed in the database. The at least one of the circuit and the processor may be configured to acquire the re-encrypted information from secure computation using the encrypted information and the decrypted information.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an example of a supply chain according to an embodiment of the present disclosure;

FIG. 2 is a diagram illustrating an overall image of the supply chain management system;

FIG. 3 is a block diagram illustrating a configuration of a transactor terminal;

FIG. 4 is a block diagram illustrating a configuration of a management server;

FIG. 5 is a block diagram illustrating a configuration of a supervisory authority/CFP management organization server;

FIG. 6 is a flowchart illustrating details of four arithmetic operations of a numerical value encrypted with different public keys;

FIG. 7 is a flowchart illustrating details of a bootstrapping process;

FIG. 8 is a flowchart illustrating details of a data disclosure request;

FIG. 9 is a flowchart illustrating details of generation of a private key and a public key;

FIG. 10A is a flowchart illustrating details of key name distribution;

FIG. 10B is a flowchart illustrating details of key name distribution;

FIG. 11 is a flowchart illustrating details of CFP calculation using homomorphic encryption at a time of an addition/integration process in a case where there is no preceding process;

FIG. 12 is a flowchart illustrating details of the CFP calculation using the homomorphic encryption at a time of the addition/integration process in a case where there is a preceding process;

FIG. 13 is a flowchart illustrating details of the CFP calculation using the homomorphic encryption at a time of a branching process;

FIG. 14 is a flowchart illustrating details of the CFP calculation using the homomorphic encryption in a case where a public key for a preceding process is different;

FIG. 15 is a flowchart illustrating details of the CFP calculation using the homomorphic encryption when the number of times of multiplication/division reaches an upper limit value;

FIG. 16 is a flowchart illustrating details of the CFP calculation using the homomorphic encryption, when it is desired to clear the number of times of multiplication/division calculations;

FIG. 17 is a flowchart illustrating details of processing in a case where there is a request for disclosure of a CFP value from a supervisory authority/CFP management organization; and

FIG. 18 is a flowchart illustrating details of processing in a case where there is a request for disclosure of a CFP value from an entity other than a supervisory authority/CFP management organization.

### DETAILED DESCRIPTION

As consumers and users become more aware of the environment, due diligence, and traceability, there is an increasing trend of disclosure requests and disclosure obligations for raw materials, recycling rates, a carbon footprint (CFP), environmentally hazardous substances, and the like of products. Meanwhile, companies requested to disclose information have a strong sense of resistance to the disclosure, because, for the companies, disclosure of information of raw materials, a recycling rate, CFP, or the like is equivalent to disclosing a trade secret that is a source of competitive advantage.

In particular, there is an increasing demand for disclosure of CFP, a typical example of which is the EU battery regulation, or the like. The CFP is often a trade secret. This is because, although the CFP seems to be merely information of a carbon dioxide emission amount, other companies in the same industry are able to roughly estimate raw materials, processing methods, and the like from CFP values. In addition, there are many cases in which the disclosure is not desired because the CFP values may directly affect purchase behaviors and may lead to price reduction, or the like.

When a normal encryption system as disclosed in a related art is merely used for information management of a supply chain, exchange of private keys, exchange of decrypted values, and the like with a supervisory authority, a supply chain management organization, and the like on a server or the like on a network are required. Even if security of the network itself is secured, there is a possibility that a malicious hacker or the like intercepts and sees a value or the like decrypted with an illegally obtained private key or the like. Therefore, it is necessary to further enhance the security.

The present disclosure provides an information processing device, an information processing system, and an information processing method with enhanced security, which do not exchange private keys and decrypted values on a network at all.

According to one aspect of the present disclosure, an information processing device that manages item-related information related to an item handled by a plurality of transactors that constitutes a supply chain is provided. The information processing device includes: a database that stores each of a plurality of sets of a private key based on homomorphic encryption and a public key corresponding to the private key in association with a key name; an encrypted information acquisition section that acquires, from a transactor terminal of the transactor, encrypted information obtained by encrypting item-related information by using a public key, and a key name of the public key used to encrypt the item-related information; a key acquisition section that acquires, from the database, a private key corresponding to the key name; a decrypted information acquisition section that acquires decrypted information by decrypting, with the private key, the encrypted information; an encryption processing section acquires re-encrypted information by encrypting the decrypted information; and a provision section that provides the re-encrypted information encrypted by the encryption processing section to the transactor terminal. The encrypted information acquisition section further acquires, from the transactor terminal of the transactor, encrypted information encrypted by using a public key that is a public key based on homomorphic encryption and is a public key different from a public key managed in the database. The encryption processing section acquires the re-encrypted information from secure computation using the encrypted information and the decrypted information.

Another disclosed embodiment is an information processing system comprising the above-described information processing device and a transactor terminal of the transactor.

According to one aspect of the present disclosure, an information processing method for managing item-related information related to an item handled by a plurality of transactors that constitutes a supply chain is provided. The information processing method includes: recording, in a database, each of a plurality of sets of a private key based on homomorphic encryption and a public key corresponding to the private key in association with a key name; acquiring, from a transactor terminal of the transactor, encrypted information obtained by encrypting item-related information by using a public key, and a key name of the public key used to encrypt the item-related information; acquiring, from the database, a private key corresponding to the key name; acquiring decrypted information by decrypting, with the private key, encrypted information; acquiring re-encrypted information by encrypting the decrypted information; and providing the re-encrypted information to the transactor terminal. In acquiring the encrypted information, encrypted information encrypted by using a public key that is a public key based on homomorphic encryption and is a public key different from a public key managed in the database is further acquired from the transactor terminal of the transactor. In acquiring the re-encrypted information, the re-encrypted information is acquired from secure computation using the encrypted information and the decrypted information.

In these aspects, processing is performed in which encrypted information encrypted by using a public key and a key name used for encryption are acquired from a transactor terminal, a private key is searched from the acquired key name to decrypt the encrypted information, and re-encrypted information based on the decrypted information is provided to the transactor terminal. According to the above, by using the private key in the information processing device, it is not necessary to distribute the private key. Therefore, even if the security of the network itself is secured, it is possible to prevent a situation in which a malicious hacker or the like intercepts and the value decrypted with the illegally obtained private key is seen, and to improve the security. Furthermore, because the information transmitted from the information processing device to the transactor terminal is encrypted, an actual value is not known by the hacker even if the information is intercepted by the hacker. Thus, security can be improved.

It should be noted that the reference numerals in parentheses in the above description and in the claims merely indicate one example of correspondence with specific components in the embodiments described later, and do not in any way limit the technical scope of the invention. Furthermore, unless there is a particular impediment to combination, it is also possible to combine claim items that are not explicitly described as combinations in the claims. Hereinafter, an embodiment of the present disclosure will be described with reference to the drawings. Note that, in the embodiment, redundant description may be omitted by providing the same reference numerals to corresponding components.

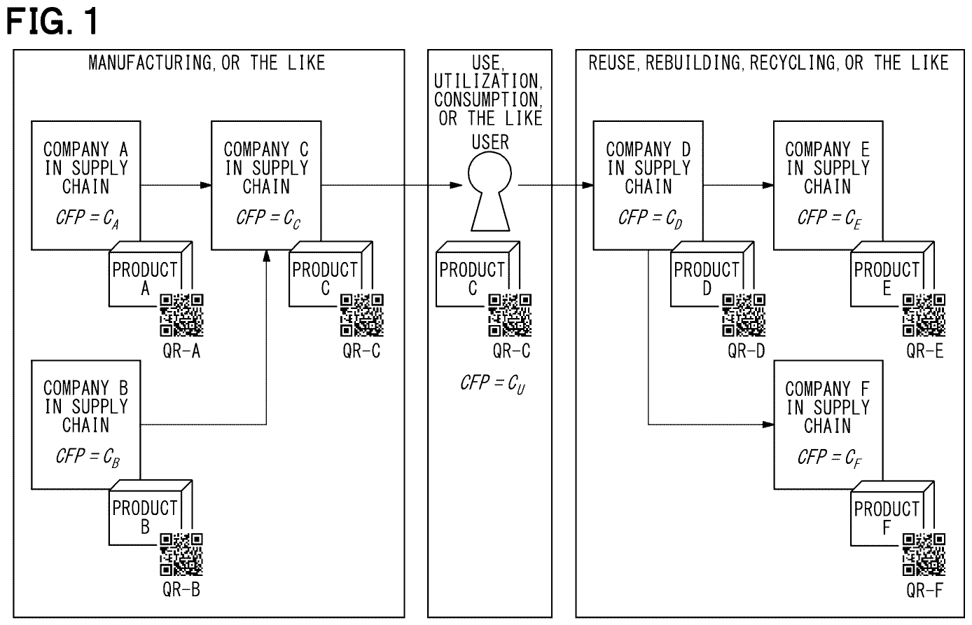

FIG. 1 is a diagram illustrating an example of a supply chain according to the embodiment of the present disclosure. A supply chain SC illustrated in FIG. 1 is a connection between transactors for sending industrial products, agricultural products, marine products, and the like to end users. The supply chain SC is constructed by a large number of transactors (refer to companies A to F in FIG. 1). Final products supplied by the supply chain SC may be various articles such as automobiles, batteries, semiconductors, fresh food, marine products, food, flower crops, pharmaceutical products, and chemical products, for example.

In the example in FIG. 1, the company C purchases a product A from the company A, purchases a product B from the company B, and manufactures a final product C. The company C sends the product C to a user who is a consumer, and the user sells the product C to the company D as a recycled product. The company D repairs the product C and manufactures a product D, and delivers a portion of the product D to each of the company E and the company F. Then, the company E and the company F manufacture a product E and a product F, respectively.

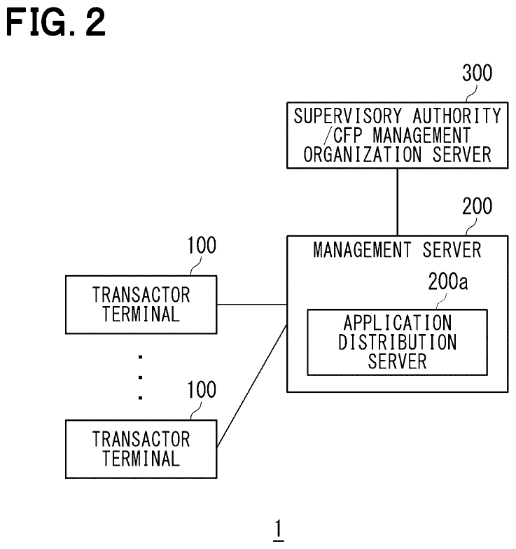

FIG. 2 is a diagram illustrating an overall image of a supply chain management system 1. The supply chain management system 1 according to the embodiment of the present disclosure manages, as information associated with each transactor, a transaction record of an item transacted between respective transactors in the supply chain SC. The transaction record is history information that achieves traceability of items transacted between transactors, and includes a large number of pieces of information indicating times, places, and the like when transactions have occurred.

The supply chain management system 1 further manages item-related information related to an item to be transacted, in addition to a transaction record thereof. For example, information related to raw materials, information related to processing and assembly, information related to distribution, and the like are managed as the item-related information. The supply chain management system 1 collects and accumulates information related to an emission amount of a greenhouse gas emitted in each process of manufacturing and distributing an item (hereinafter, a carbon footprint) (CFP) as one piece of the item-related information.

The supply chain management system 1 can acquire a CFP value of each transactor and present the CFP value to the user, a supervisory authority, a CFP management organization, and the like. The CFP may include a carbon release amount in processes such as mining and recycling of raw materials of the item, and a carbon release amount in processes related to disposal such as incineration and landfill of an item.

Note that the greenhouse gas whose emission amount is recorded may be only carbon dioxide, and may appropriately contain greenhouse gases other than carbon dioxide, specifically, methane, nitrous oxide, hydrofluorocarbons, perfluorocarbons, sulfur hexafluoride, and the like. In this case, an emission amount of greenhouse gas other than carbon dioxide is converted into the emission amount of carbon dioxide and is included into a presented value of the carbon footprint.

Here, the CFP value is often a trade secret in each transactor TR. This is because rough raw materials, processing methods, and the like may be analogized from the CFP value. Therefore, many companies do not want to disclose the CFP value to other transactors, consumers, and the like. Against such a background, the supply chain management system 1 performs secure computation on a network without exchanging private keys and numerical values, which are obtained by decrypting CFP values belonging to each transactor, at all. Hereinafter, details of the supply chain management system 1 will be described with reference to FIGS. 2 to 5.

The supply chain management system 1 includes a large number of transactor terminals 100, a management server 200, an application distribution server 200a, and a supervisory authority/CFP management organization server 300. Each element that constitutes the supply chain management system 1 is connected to the network as one node and the respective elements can communicate with each other.

### Transactor Terminal 100

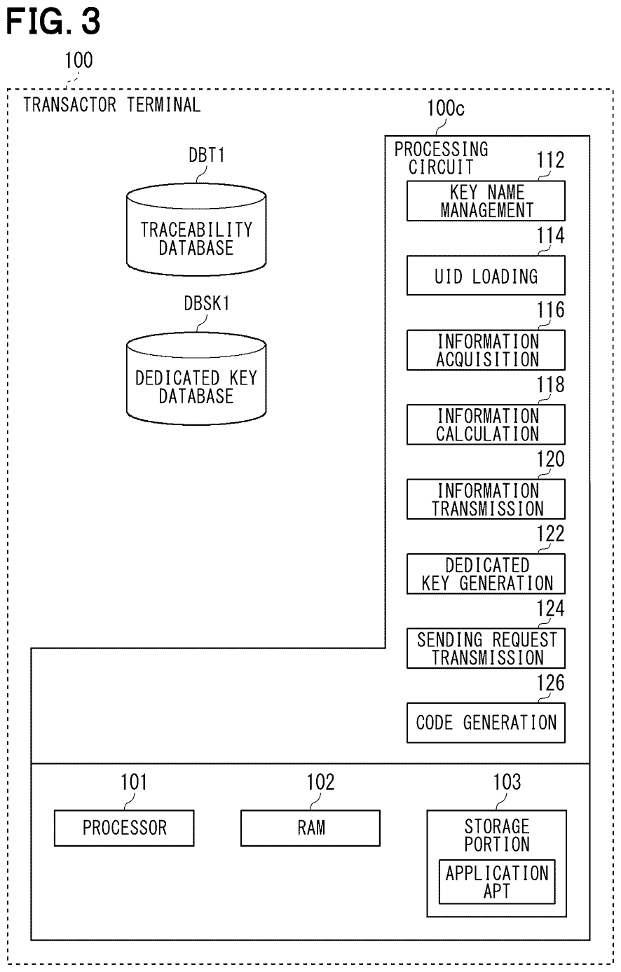

FIG. 3 is a block diagram illustrating a configuration of a transactor terminal 100. The transactor terminal 100 is an information processing device operated by each transactor. For example, a smartphone, a tablet terminal, a personal computer, or the like can be utilized as the transactor terminal 100. The transactor terminal 100 is associated with each of the companies A to F (refer to FIG. 1). The transactor terminal 100 is utilized by each transactor to collect and accumulate transaction records and the item-related information. The transactor terminal 100 records, as transaction records, delivery information such as from which transactor raw materials, parts, or the like are purchased and when they are acquired, and shipping information such as to which transactor and when they are shipped. The transactor terminal 100 records at least information related to cost, the CFP value, and the like as the item-related information.

The transactor terminal 100 has a configuration mainly including a processing circuit 100c. The processing circuit 100c includes a processor 101, a random access memory (RAM) 102, a storage portion 103, an input/output interface, a bus connecting these, and the like, and functions as a computer that performs arithmetic processing. The processor 101 is hardware for arithmetic processing coupled with the RAM 102. The storage portion 103 stores an application program (information management application APT) for causing the processing circuit 100c to execute the information processing method according to the present disclosure. A display, a code reader (or a camera), a printer, and the like are electrically connected to the input/output interface. The display, the code reader, and the printer may be integrated with the transactor terminal 100, or may be electrically connected to the transactor terminal 100 in a wired or wireless manner.

When the processor 101 executes the information management application APT stored in the storage portion 103, the transactor terminal 100 includes functional sections such as a key name management section 112, a UID loading section 114, an information acquisition section 116, an information calculation section 118, an information transmission section 120, a dedicated key generation section 122, a sending request transmission section 124, and a code generation section 126.

The key name management section 112 manages a key name of a set of a private key and a public key based on homomorphic encryption. The transactor terminal 100 of the present embodiment does not manage sets of a private key and a public key, but manages only key names. The private key and the public key are used to encrypt and decrypt the item-related information corresponding to the trade secret. The homomorphic encryption is an encryption method capable of processing data in an encrypted state without decrypting the encrypted data. As the homomorphic encryption, for example, fully homomorphic encryption such as fully homomorphic encryption (FHE) is utilized. The fully homomorphic encryption allows for addition, subtraction, multiplication and division of data in an encrypted state. Instead of the fully homomorphic encryption, multiplicative homomorphic encryption such as RSA encryption and EIGamal encryption, and additive homomorphic encryption such as Goldwasser-Micali encryption and Paillier encryption can be utilized according to processing content of the secure computation to be described later.

The UID loading section 114 is a code reader that loads a code, such as a one-dimensional code or a two-dimensional code (for example, a QR code (registered trademark)), attached to the item. In the code, a unique identification ID (hereinafter, UID) generated from the transaction record and the item-related information is recorded.

The information acquisition section 116 requests the management server 200 for information including a transaction record of the item, item-related information, and a key name (hereinafter, traceability information) by using the UID read by the UID loading section 114 as an argument. Then, the information acquisition section 116 acquires the traceability information corresponding to the read UID from the management server 200. The item-related information includes information related to the CFP value described above, in addition to information related to a procedure (processing, assembly, transportation, storage, and the like, for example) performed on the item by the transactor.

The information acquisition section 116 stores the traceability information in a traceability database DBT1 in a state where the traceability information is associated with each UID of the item. By using the UID as a search key, the information acquisition section 116 extracts the traceability information corresponding to the UID, from the data accumulated in the traceability database DBT1. Note that the traceability database DBT1 may be a local storage device provided at a site of the transactor or may be a storage on a cloud.

The information calculation section 118 performs various calculations related to the traceability information. Specific processing of the information calculation section 118 will be described later.

To the management server 200, the information transmission section 120 transmits the traceability information collected by the transactor terminal 100. The information transmission section 120 associates the traceability information with the UID generated by the code generation section 126, and transmits the traceability information to the management server 200.

The dedicated key generation section 122 generates a set of the private key and the public key dedicated to a transactor who handles the transactor terminal 100. The set of the private key and the public key dedicated to the transactor is not included in a key database DBK of the management server 200. The generated set of the private key and the public key dedicated to the transactor is recorded in a dedicated key database DBSK1.

The sending request transmission section 124 transmits various sending requests to the management server 200.

The code generation section 126 is connected to the printer. The code generation section 126 causes the printer to output a label on which a two-dimensional code or the like is printed. The label is attached to a shipping item and distributed to a transactor of a next process, together with the shipping item. Note that the two-dimensional code may be directly laser-engraved or printed on the item. In this case, instead of the printer, a laser marker, an inkjet printer, or the like can be utilized as an output device.

### Management Server 200

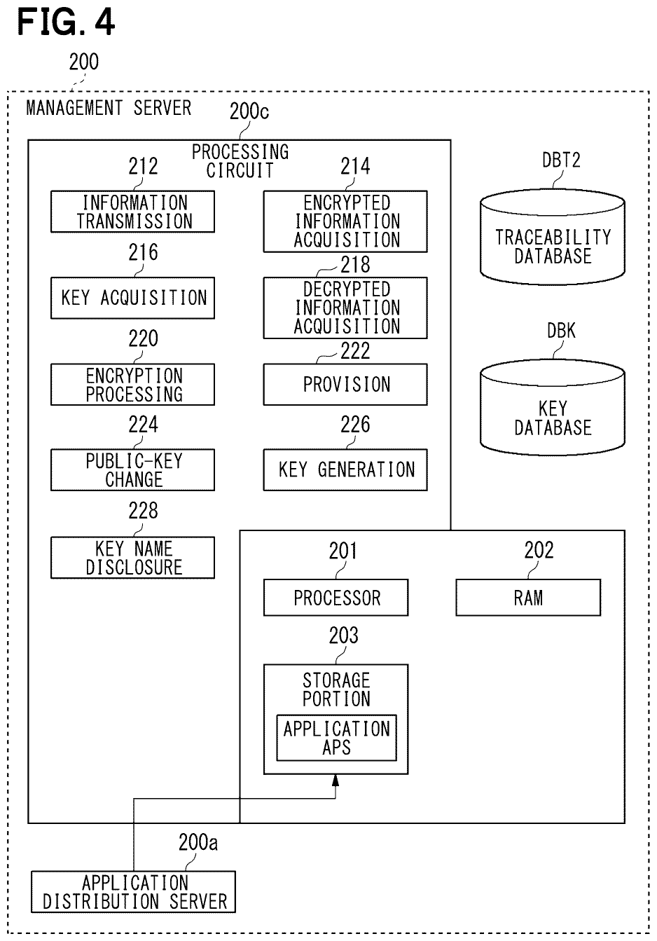

FIG. 4 is a block diagram illustrating a configuration of the management server 200. The management server 200 and the application distribution server 200a are server devices operated by an administrator of the supply chain SC. The administrator is, for example, an agency entrusted with management operations by a provider (finished product manufacturer) of a final product supplied by the supply chain SC. The administrator may be an agency entrusted with management and audit operations by a supervisory authority having authority to supervise a category to which the final product belongs. The management server 200 and the application distribution server 200a may have an on-premises configuration physically managed by an administrator, a system transactor, or the like, or may have a virtual server configuration provided on the cloud.

The management server 200 is an information processing device mainly including a processing circuit 200c. The processing circuit 200c includes a processor 201, a RAM 202, a storage portion 203, an input/output interface, a bus connecting these, and the like, and functions as a computer that performs arithmetic processing. The processor 201 is hardware for arithmetic processing coupled with the RAM 202, and executes a program stored in the storage portion 203.

The management server 200 is an information processing device on an administrator side that manages item-related information related to items handled by a plurality of transactors that constitutes the supply chain SC. The storage portion 203 stores an application program (information management application APS) for causing the processing circuit 200c to perform the information processing method according to the present disclosure. When the processor 201 executes the information management application APS, the management server 200 includes functional sections such as an information transmission section 212, an encrypted information acquisition section 214, a key acquisition section 216, a decrypted information acquisition section 218, an encryption processing section 229, a provision section 222, a public-key change section 224, a key generation section 226, and a key name disclosure section 228. The management server 200 includes the key database DBK that stores each of a plurality of sets of a private key based on the homomorphic encryption and a public key corresponding to the private key in association with a key name.

The information transmission section 212 extracts from a traceability database DBT2 traceability information requested from the transactor terminal 100, and transmits the traceability information to the transactor terminal 100.

The encrypted information acquisition section 214 acquires, from the transactor terminal 100, the encrypted information obtained by encrypting the item-related information by using the public key, and a key name of the public key used to encrypt the item-related information. Note that the encrypted information acquisition section 214 also functions as an information acquisition section that acquires traceability information from the transactor terminal 100. In the traceability database DBT2, the traceability information acquired by the encrypted information acquisition section 214 is recorded in association with the UID.

The key acquisition section 216 acquires the private key corresponding to the key name from the key database DBK.

The decrypted information acquisition section 218 acquires decrypted information by decrypting, with the private key, the encrypted information obtained by encrypting the item-related information.

The encryption processing section 220 acquires re-encrypted information by encrypting the decrypted information.

The provision section 222 provides the re-encrypted information encrypted by the encryption processing section 220 to the transactor terminal 100.

The public-key change section 224 changes the encrypted information encrypted with a public key A to encrypted information encrypted with a public key B different from the public key A.

The key generation section 226 generates a set of a private key and a public key requested to be created by a supervisory authority/CFP management organization.

The key name disclosure section 228 discloses the key name of the created set of the private key and the public key. For example, the key name disclosure section 228 discloses the key name of the created key to the supervisory authority/CFP management organization that has requested creation of the key.

### Supervisory Authority/CFP Management Organization Server 300

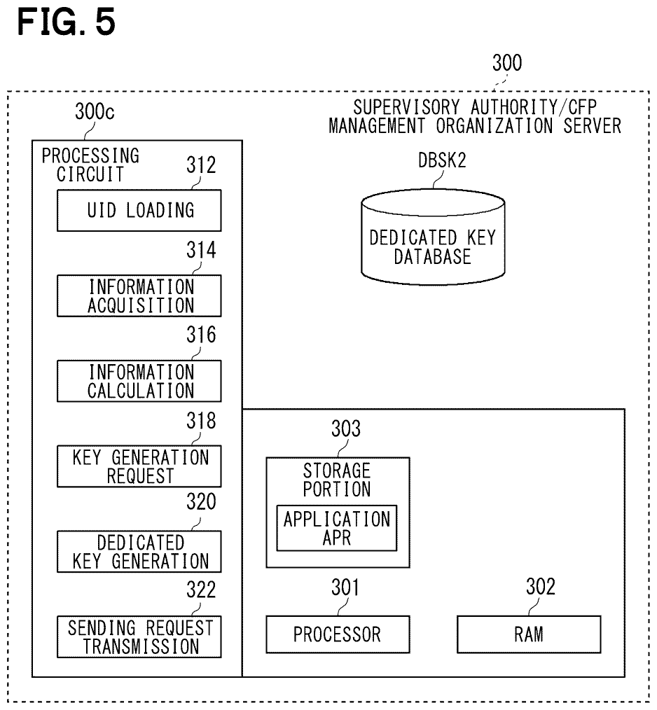

FIG. 5 is a block diagram illustrating a configuration of the supervisory authority/CFP management organization server 300. The supervisory authority/CFP management organization server 300 is a server device operated by the supervisory authority or the CFP management organization. The supervisory authority/CFP management organization server 300 may have an on-premises configuration physically managed by the supervisory authority or the CFP management organization, or may have a virtual server configuration provided on the cloud.

The supervisory authority/CFP management organization server 300 is an information processing device mainly including a processing circuit 300c. The processing circuit 300c includes a processor 301, a RAM 302, a storage portion 303, an input/output interface, a bus connecting these, and the like, and functions as a computer that performs arithmetic processing. The processor 301 is hardware for arithmetic processing coupled with the RAM 302, and executes a program stored in the storage portion 303.

The supervisory authority/CFP management organization server 300 is an information processing device of the supervisory authority or the CFP management organization. The storage portion 203 stores an application program (information management application APR) for causing the processing circuit 300c to perform the information processing method according to the present disclosure. When the processor 301 executes the information management application APR, the supervisory authority/CFP management organization server 300 includes functional sections such as an UID loading section 312, an information acquisition section 314, information calculation section 316, a key generation request section 318, a dedicated key generation section 320, and a sending request transmission section 322.

The UID loading section 312 is a code reader that loads a code, such as a one-dimensional code or a two-dimensional code (a QR code (registered trademark), for example), attached to the item. In the code, a unique UID generated from the transaction record and item-related information is recorded.

The information acquisition section 314 requests the management server 200 for the traceability information by using the UID read by the UID loading section 312 as an argument, and acquires the traceability information corresponding to the read UID from the management server 200.

The information calculation section 316 performs various calculations related to the traceability information. Specific processing of the information calculation section 316 will be described later.

The key generation request section 318 requests the management server 200 to generate a set of a private key and a public key.

The dedicated key generation section 320 generates the set of the private key and the public key dedicated to the supervisory authority or the CFP management organization, the private key and public key being handled by the supervisory authority/CFP management organization server 300. The set of the private key and the public key dedicated to the supervisory authority or the CFP management organization is not included in a key database DBK of the management server 200. The generated set of the private key and the public key dedicated to the supervisory authority or the CFP management organization is recorded in a dedicated key database DBSK2.

Next, processing using the homomorphic encryption executed in the supply chain management system 1 of the present embodiment will be described. Exchange of a private key and an actual value of an unencrypted item-related information over a network is also problematic in terms of security. Therefore, in the present embodiment, a property of the homomorphic encryption is utilized. The property is that it is possible to add a numerical value of plaintext information even without an encryption key, as long as there is an encrypted numerical value.

However, the homomorphic encryption has the following restrictions.

Restriction 1: To add up encrypted numerical values, the encrypted values need to be encrypted with the same encryption key.

Restriction 2: The number of times of multiplication/division is limited. A bootstrapping process (decrypted once, then re-encrypted) is required to prevent accumulation of calculation errors, but a private key is required for decryption required at a time of the bootstrapping process.

Restriction 3: A private key is required to know an actual value of the encrypted numerical value.

A private key Kₚᵣᵥ^{Adm} is required to solve Restrictions 2 and 3, but the private key Kₚᵣᵥ^{Adm} cannot be exchanged on the network. Therefore, it is only required that processing using the private key Kₚᵣᵥ^{Adm} is performed on one management server (the management server 200 of the present embodiment).

Regarding Restriction 3, when decryption is performed on one management server, in order to transmit an actual value obtained by the decryption to another server, it is necessary to exchange on the network the actual value obtained by the decryption. To avoid this, a set of the private key Kₚᵣᵥ and the public key K_{pub} is independently created by a terminal requesting decryption, a value of 0 is encrypted (Enc (0, K_{pub})) with the public key K_{pub}, and encrypted data Enc (0, K_{pub}) of 0 and encrypted data (Enc (x₁, K_{pub}^{Adm})) desired to be decrypted are transmitted to the management server. Then, a management server side decrypts Enc (x₁, K_{pub}^{Adm}) to obtain x₁, adds x₁ to Enc (0, K_{pub}), and then transmits Enc (0+x₁, K_{pub}) to the terminal requesting the decryption. The terminal that has requested the decryption decrypts Enc (0+x₁, K_{pub}) with its own private key Kₚᵣᵥ.

With respect to the bootstrapping process in Restriction 2, similarly to the idea described above, Enc (x₁, K_{pub}^{Adm}) is transmitted to the management server, decrypted by the management server by using the private key Kₚᵣᵥ^{Adm}, and the decrypted value is encrypted again with the public key K_{pub}^{Adm} and then returned to a requester terminal of the bootstrapping process.

Regarding Restriction 1, in order to add up values of encryption using different encryption keys, all encrypted numerical values (Enc (x₁, K_{pub}^{Adm1}) and Enc (x₂, K_{pub}^{Adm2}) are sent to the management server, each of which is decrypted with a private key Kₚᵣᵥ^{Adm1} and a private key Kₚᵣᵥ^{Adm2} to acquire x₁ and x₂, and then x₁+x₂ is encrypted again with K_{pub}^{Adm3}, and Enc (x₁+x₂,K_{pub}^{Adm3}) is returned to the requester terminal that has requested calculation of the encrypted information.

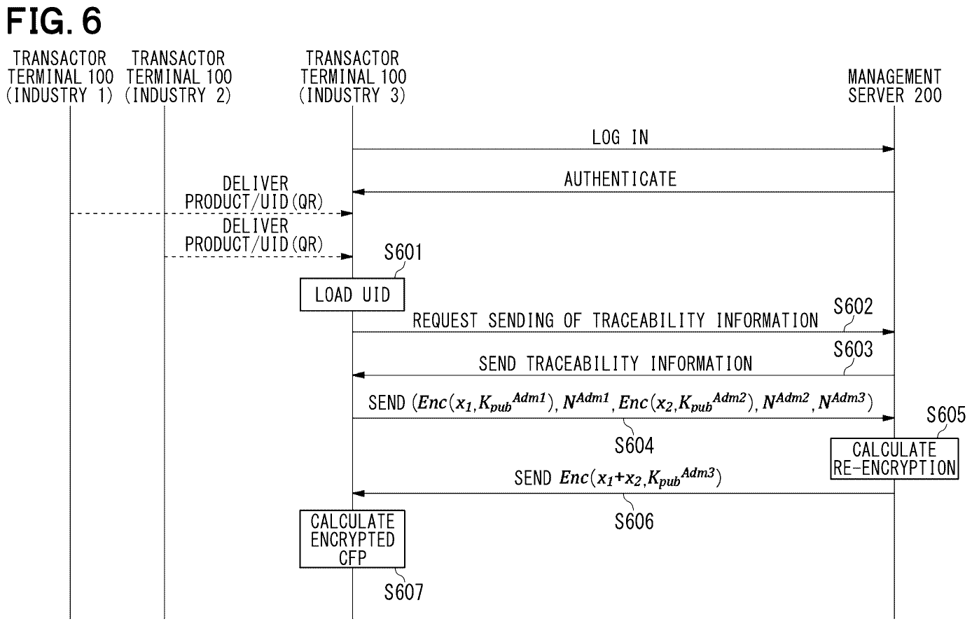

Hereinafter, processing of the supply chain management system 1 for solving the above-described Restrictions 1 to 3 without exchanging the private key and the actual value of the unencrypted item-related information on the network will be described in detail with reference to FIGS. 6 to 8. Hereinafter, symbols used for description will be defined. Note that an industry refers to a classification of a company of a transactor.
Kₚᵣᵥ^{Adm1}: a private key that serves as a source of encryption and is used in an industry 1
K_{pub}^{Adm1}: a public key used in the industry 1
N^{Adm1}: a key name of a key used in the industry 1
Kₚᵣᵥ^{Adm2}: a private key that serves as a source of encryption and is used in an industry 2
K_{pub}^{Adm2}: a public key used in the industry 2
N^{Adm2}: a key name of a key used in the industry 2
Kₚᵣᵥ^{Adm3}: a private key that serves as a source of encryption and is used in an industry 3
K_{pub}^{Adm3}: a public key used in the industry 3
N^{Adm3}: a key name of a key used in the industry 3
x₁: a numerical value (example: a CFP value required to produce a certain product in the industry 1)
x₂: a numerical value (example: a CFP value required to produce a certain product in the industry 2)
x₃: a numerical value (example: a CFP value required to produce a certain product in the industry 3)
Enc (x, K_{pub}^{Adm1}): a numerical value x encrypted with a public key used in the industry 1
Enc (x, K_{pub}^{Adm2}): a numerical value x encrypted with a public key used in the industry 2
Enc (x, K_{pub}^{Adm3}): a numerical value x encrypted with a public key used in the industry 3

FIG. 6 is a flowchart illustrating details of four arithmetic operations of a numerical value encrypted with different public keys. The four arithmetic operations of numerical values encrypted with different public keys corresponding to Restriction 1 will be described with reference to FIG. 6. The processing is started when a transactor terminal 100 of a transactor in the industry 3 logs in the management server 200, and the management server 200 authenticates the login.

In S601, the UID loading section 114 loads a UID attached to a product delivered from each of a transactor of the industry 1 and a transactor of the industry 2. Note that, in FIG. 6, delivery from a transactor terminal 100 of the transactor in the industry 1 and a transactor terminal 100 of the transactor in the industry 2 to the transactor terminal 100 of the transactor in the industry 3 is denoted by dotted lines, because the product delivery does not represent exchange of signals but movement of a real product.

In S602, the sending request transmission section 124 transmits a request for sending traceability information by using the UIDs loaded into the management server 200 as arguments.

In S603, the information transmission section 212 of the management server 200 transmits the traceability information corresponding to the loaded UIDs to the transactor terminal 100.

In S604, the information calculation section 118 transmits a request for addition of Enc (x₁, K_{pub}^{Adm1}) and Enc (x₂, K_{pub}^{Adm2}) to the encrypted information acquisition section 214 of the management server 200, together with Enc (x₁, K_{pub}^{Adm1}), N^{Adm1}, Enc (x₂, K_{pub}^{Adm2}), N^{Adm2}, and N^{Adm3} in the acquired traceability information.

In S605, the key acquisition section 216 searches for sets of a private key and a public key ((Kₚᵣᵥ^{Adm1}, K_{pub}^{Adm1}), (Kₚᵣᵥ^{Adm2}, K_{pub}^{Adm2}), and (Kₚᵣᵥ^{Adm3}, K_{pub}^{Adm3})) corresponding to the respective key names N^{Adm1}, N^{Adm2}, and N^{Adm3} acquired by the encrypted information acquisition section 214, and acquires the sets of a private key and a public key ((Kₚᵣᵥ^{Adm1}, K_{pub}^{Adm1}), (Kₚᵣᵥ^{Adm2}, K_{pub}^{Adm2}), and (Kₚᵣᵥ^{Adm3}, K_{pub}^{Adm3})) from the key database DBK. The decrypted information acquisition section 218 decrypts Enc (x₁, K_{pub}^{Adm1}) and Enc (x₂, K_{pub}^{Adm2}) with the acquired private keys Kₚᵣᵥ^{Adm1} and Kₚᵣᵥ^{Adm2} to obtain x₁ and x₂. The encryption processing section 220 calculates encrypted information Enc (x₁+x₂, K_{pub}^{Adm3}) by using x₁, x₂, and K_{pub}^{Adm3}.

In S606, the provision section 222 transmits the encrypted information Enc (x₁+x₂, K_{pub}^{Adm3}) to the transactor terminal 100 of the transactor in the industry 3.

In S607, the information calculation section 118 performs secure computation of adding x₃ to the encrypted information Enc (x₁+x₂, K_{pub}^{Adm3}) to acquire encrypted information Enc (x₁+x₂+x₃, K_{pub}^{Adm3}). As described above, the information calculation section 118 has a function as a secure computation section that generates encrypted information with secure computation using encrypted information and plaintext information of item-related information.

With the processing described above, the four arithmetic operations of numerical values encrypted with different public keys can be performed on one management server 200. Information exchanged on the network is only key names and encrypted information, and private keys and decrypted actual numerical values are not exchanged on the network. Therefore, security can be improved. In addition, according to the present embodiment, although the public keys may be distributed, there is no need to distribute even the public keys, and sets of the private key and the public key are managed by the key database DBK of one management server 200.

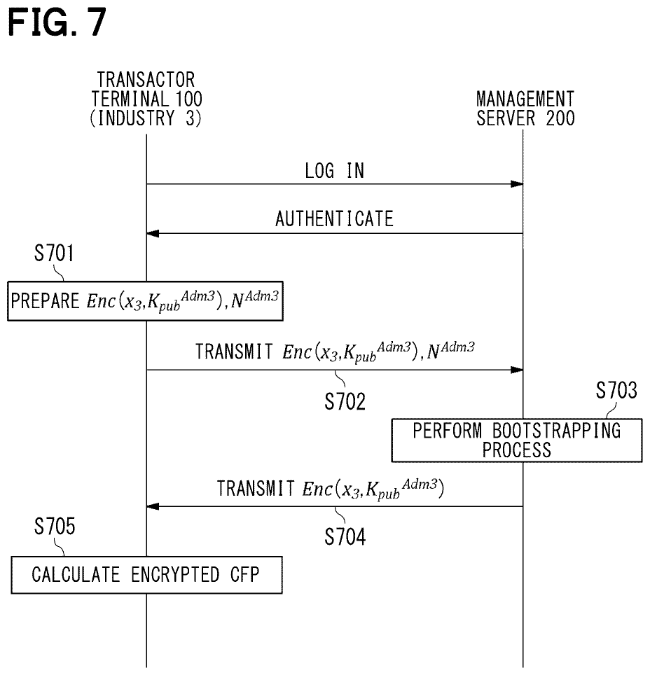

FIG. 7 is a flowchart illustrating details of the bootstrapping process. The bootstrapping process corresponding to Restriction 2 will be described with reference to FIG. 7. The processing is started when a transactor terminal 100 of a transactor in the industry 3 logs in the management server 200, and the management server 200 authenticates the login.

In S701, the information calculation section 118 prepares Enc (x₃, K_{pub}^{Adm3}) and N^{Adm3}.

In S702, the information transmission section 120 transmits a request for the bootstrapping processing of Enc (x₃, K_{pub}^{Adm3}) to the management server 200, together with Enc (x₃, K_{pub}^{Adm3}) and N^{Adm3}.

In S703, the key acquisition section 216 searches for a set of a private key and a public key (Kₚᵣᵥ^{Adm3}, K_{pub}^{Adm3}) corresponding to the key name N^{Adm3} acquired by the encrypted information acquisition section 214, and acquires the set of the private key and the public key (Kₚᵣᵥ^{Adm3}, K_{pub}^{Adm3}) from the key database DBK. The decrypted information acquisition section 218 decrypts Enc (x₃, K_{pub}^{Adm3}) with the acquired private key Kₚᵣᵥ^{Adm3} to obtain x₃. The encryption processing section 220 calculates encrypted information Enc (x₃, K_{pub}^{Adm3}) (performs the bootstrapping process) by using x₃ and K_{pub}^{Adm3}.

In S704, the provision section 222 transmits the encrypted information Enc (x₃, K_{pub}^{Adm3}) to the transactor terminal 100 of the transactor in the industry 3.

In S705, the information calculation section 118 updates the number of times of multiplication/division (M^{Adm3}=0), and performs multiplication/division on the encrypted information Enc (x₃, K_{pub}^{Adm3}).

With the processing described above, the bootstrapping process can be performed on one management server 200. Information exchanged on the network is only key names and encrypted information, and private keys and decrypted actual numerical values are not exchanged on the network. Therefore, security can be improved.

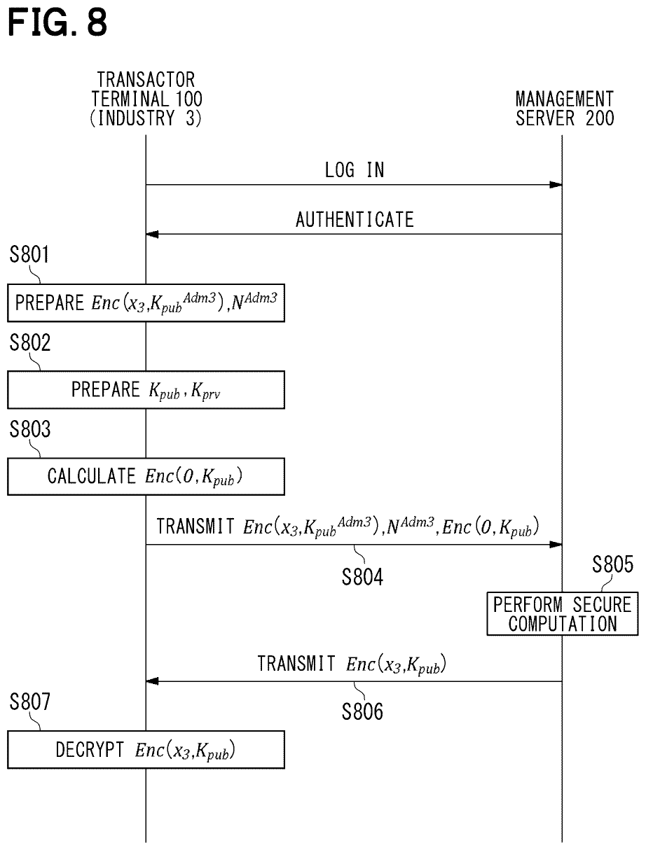

FIG. 8 is a flowchart illustrating details of a data disclosure request. The data disclosure request corresponding to Restriction 3 will be described with reference to FIG. 8. The processing is started when a transactor terminal 100 of a transactor in the industry 3 logs in the management server 200, and the management server 200 authenticates the login.

In S801, the information calculation section 118 prepares the encrypted information Enc (x₃, K_{pub}^{Adm3}) and N^{Adm3} that are to be decrypted.

In S802, the dedicated key generation section 122 creates and prepares a dedicated set of a private key Kₚᵣᵥ and a public key K_{pub}.

In S803, the information calculation section 118 encrypts a numerical value 0 by using the public key K_{pub} and calculates encrypted information Enc (0, K_{pub}).

In S804, the information transmission section 120 transmits a request for disclosing data of Enc (x₃, K_{pub}^{Adm3}) to the management server 200, together with Enc (x₃, K_{pub}^{Adm3}), N^{Adm3}, and Enc (0, K_{pub}).

In S805, the key acquisition section 216 searches for the set of the private key and the public key (Kₚᵣᵥ^{Adm3}, K_{pub}^{Adm3}) corresponding to the acquired key name N^{Adm3}, and acquires the set of the private key and the public key (Kₚᵣᵥ^{Adm3}, K_{pub}^{Adm3}) from the key database DBK. The decrypted information acquisition section 218 decrypts Enc (x₃, K_{pub}^{Adm3}) with the acquired private key Kₚᵣᵥ^{Adm3} to obtain x₃. The encryption processing section 220 calculates encrypted information Enc (x₃, K_{pub}) with secure computation in which Enc (0, K_{pub}) is added to x₃.

In S806, the provision section 222 transmits the encrypted information Enc (x₃, K_{pub}) to the transactor terminal 100 of the transactor in the industry 3.

In S807, the information calculation section 118 decrypts the encrypted information Enc (x₃, K_{pub}) by using the dedicated private key Kₚᵣᵥ to acquire x₃.

With the processing described above, a request for disclosing data can be made on one management server 200. Information exchanged on the network is only key names and encrypted information, and private keys and decrypted actual numerical values are not exchanged on the network. Therefore, security can be improved. Note that, in S804, the transactor terminal 100 transmits the encrypted information Enc (0, K_{pub}) of the numerical value 0 to the management server 200, but may transmit encrypted information of a predetermined value other than 0 to the management server 200. In this case, the transactor is only required to grasp the predetermined value and subtract the predetermined value from the value obtained by decrypting the encrypted information transmitted from the management server 200 in S806.

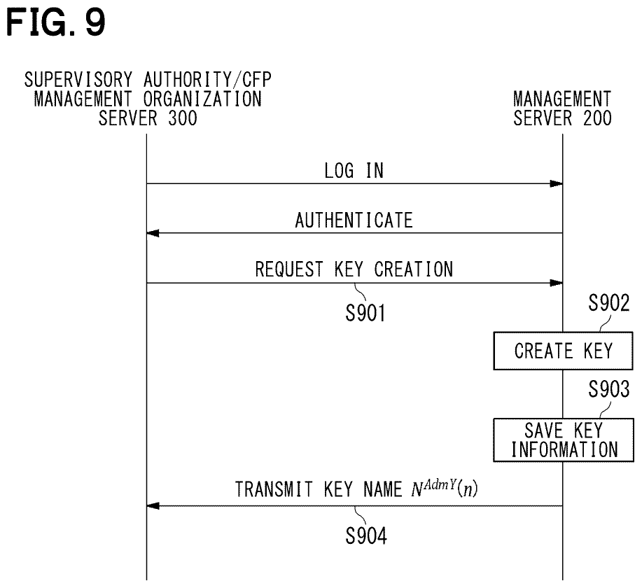

Next, basic flows when the supply chain management system 1 of the present embodiment is implemented will be described with reference to FIGS. 9 to 18. Hereinafter, symbols used for description will be defined.
Kₚᵣᵥ^{AdmY} (n): a private key (nth) that serves as a source of encryption and is used in the industry Y
K_{pub}^{AdmY} (n): a public key used in the industry Y (nth)
N^{AdmY} (n): a key name of a key used in the industry Y (nth)
M^{AdmY} (n): the current number of times of multiplication/division of an nth key used in the industry Y
n: The number of times of issuance of keys for each industry (expressed as n1, n2, . . . when other numbers are denoted)
Y: unique name allocated per industry (expressed as Y1, Y2, . . . when different industries are denoted)
Kₚᵣᵥ^{Adm} (n): a private key (nth) that serves as a source of encryption (in a case where there is no need to separately discuss different industries)
K_{pub}^{Adm} (n): a public key (nth) that serves as a source of encryption (in a case where there is no need to separately discuss different industries)
N^{Adm} (n): a key name (nth) that serves as a source of encryption (in a case where there is no need to separately discuss different industries)
Kₚᵣᵥ: a (single-use) private key independently created by a certain company in an industry
K_{pub}: a (single-use) public key corresponding to Kₚᵣᵥ
xₘ: a numerical value (example: a CFP value at a company m)
x: a numerical value (example: a CFP value at a company in a case where there is no need to separately discuss different companies)
Enc (x, K_{pub}^{Adm Y} (n)): a numerical value x encrypted with an nth public key used in the industry Y
Enc (x, K_{pub}^{Adm}(n)): a numerical value x encrypted with an nth public key (in a case where there is no need to separately discuss different industries)
Enc (x, K_{pub}): a numerical value x encrypted with a public key independently created by a company in a certain industry
R: a branching ratio

FIG. 9 is a flowchart illustrating details of generation of a private key and a public key. A flow of processing of generating a set of a private key and a public key will be described with reference to FIG. 9. The processing is started when the supervisory authority/CFP management organization server 300 logs in the management server 200, and the management server 200 authenticates the login.

In S901, the key generation request section 318 transmits a key creation request to the key generation section 226 of the management server 200 by using industry information Y as an argument.

In S902, the key generation section 226 sets the number of times of requests for creation n of keys for the industry information Y, and generates a set of a private key and a public key (Kₚᵣᵥ^{AdmY} (n) and K_{pub}^{AdmY} (n)) and a key name N^{AdmY} (n) of these keys.

In S903, the key generation section 226 records in the key database DBK the set of the private key and the public key (Kₚᵣᵥ^{AdmY} (n) and K_{pub}^{AdmY} (n)) and the key name N^{AdmY} (n) of these keys, including the industry information Y and the number of times of requests for creation n.

In S904, the key name disclosure section 228 transmits the key name N^{AdmY} (n) to the supervisory authority/CFP management organization server 300.

With the processing described above, in the key database DBK in the management server 200, the set of the private key and the public key (Kₚᵣᵥ^{AdmY} (n) and K_{pub}^{AdmY} (n)) and the key name N^{AdmY} (n) of these keys are recorded for each industry.

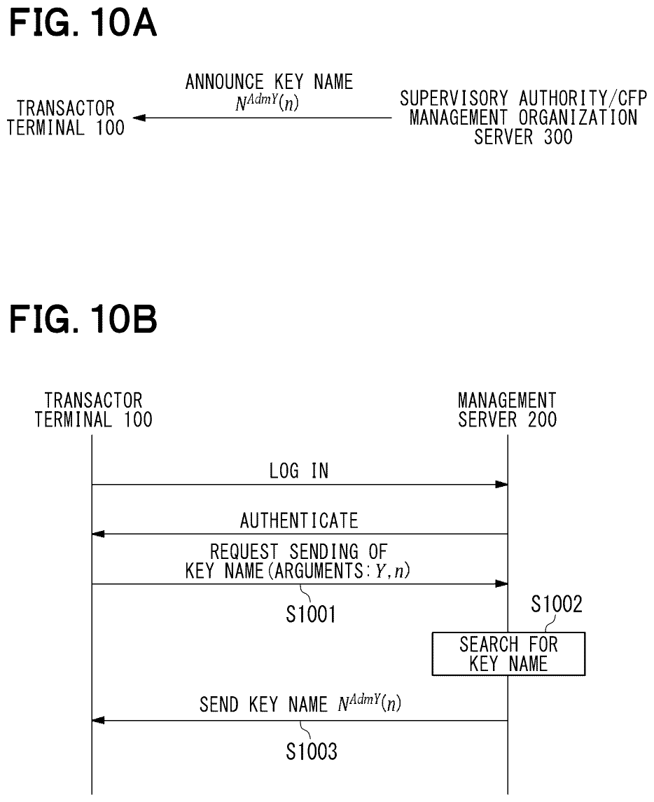

FIG. 10A and FIG. 10B are flowcharts illustrating details of key name distribution. A flow of processing of distributing a key name will be described with reference to FIG. 10A and FIG. 10B. There are two methods for the key name distribution. In the method illustrated in FIG. 10A, the supervisory authority/CFP management organization server 300 directly discloses the key name to the transactor terminal 100. For example, it is only required that the key name is posted on a website HP created on the supervisory authority/CFP management organization server 300 by the supervisory authority/CFP management organization, and that an administrator who uses the transactor terminal 100 searches for and acquires, from the website, a key name of the industry to which the administrator belongs. In the method illustrated in FIG. 10B, the transactor terminal 100 directly acquires the key name from the management server 200. A specific description will be given below. First, the transactor terminal 100 logs in to the management server 200, and the management server 200 authenticates the login. In S1001, by using the industry information Y and the number of times of the issuance n as arguments, the sending request transmission section 124 of the transactor terminal 100 transmits, to the management server 200, a request for sending the key name. In S1002, the key acquisition section 216 searches the key database DBK for and acquires the key name N^{AdmY} (n). In S1003, the key name disclosure section 228 transmits the acquired key name N^{AdmY} (n) to the transactor terminal 100. As a result, the administrator using the transactor terminal 100 can acquire the key name of the industry to which the administrator belongs.

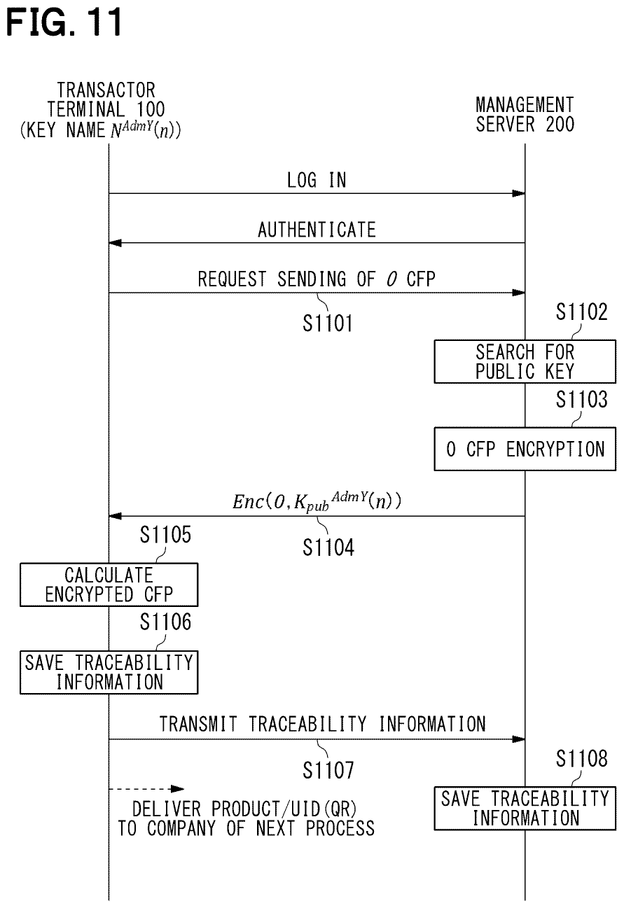

FIG. 11 is a flowchart illustrating details of CFP calculation using the homomorphic encryption at a time of an addition/integration process in a case where there is no preceding process. The CFP calculation using the homomorphic encryption in a case where there is no preceding process at a time of the addition/integration process will be described with reference to FIG. 11. The processing is started when a transactor terminal 100 of the key name N^{AdmY} (n) logs in the management server 200, and the management server 200 authenticates the login.

In S1101, by using the key name N^{AdmY} (n) of an own company as an argument, the sending request transmission section 124 of the transactor terminal 100 transmits, to the management server 200, a 0 CFP sending request. Here, the 0 CFP sending request is encrypted information encrypted when the CFP value is 0. Note that the industry information Y and the number of times of issuance n may be specified as arguments, instead of the key name N^{AdmY} (n).

In S1102, the key acquisition section 216 searches the key database DBK for and acquires a public key K_{pub}^{AdmY} (n) by using the key name N^{AdmY} (n).

In S1103, the encryption processing section 220 calculates encrypted information Enc (0, K_{pub}^{AdmY}(n)) obtained by encrypting the numerical value 0 using the acquired public key K_{pub}^{AdmY} (n) (0 CFP encryption).

In S1104, the provision section 222 transmits encrypted information Enc (0,K_{pub}^{AdmY} (n)) to the transactor terminal 100.

In S1105, the information calculation section 118 performs secure computation of adding a measured CFP value x₁ related to a product of an own company to the encrypted information Enc (0, K_{pub}^{AdmY} (n)) to acquire the encrypted information Enc (x₁, K_{pub}^{AdmY} (n)).

In S1106, the transactor terminal 100 records, in the traceability database DBT1, the traceability information including the UID, the CFP value x₁, the key name N^{AdmY} (n), an encrypted CFP (Enc (x₁, K_{pub}^{AdmY}(n))), and the number of times of multiplication/division M^{AdmY} (n)=0.

In S1107, the information transmission section 120 transmits the traceability information recorded in the traceability database DBT1 to the management server 200. Thereafter, a product with the UID is delivered to a company of a next process.

In S1108, the management server 200 records in the traceability database DBT2 the traceability information transmitted from the transactor terminal 100.

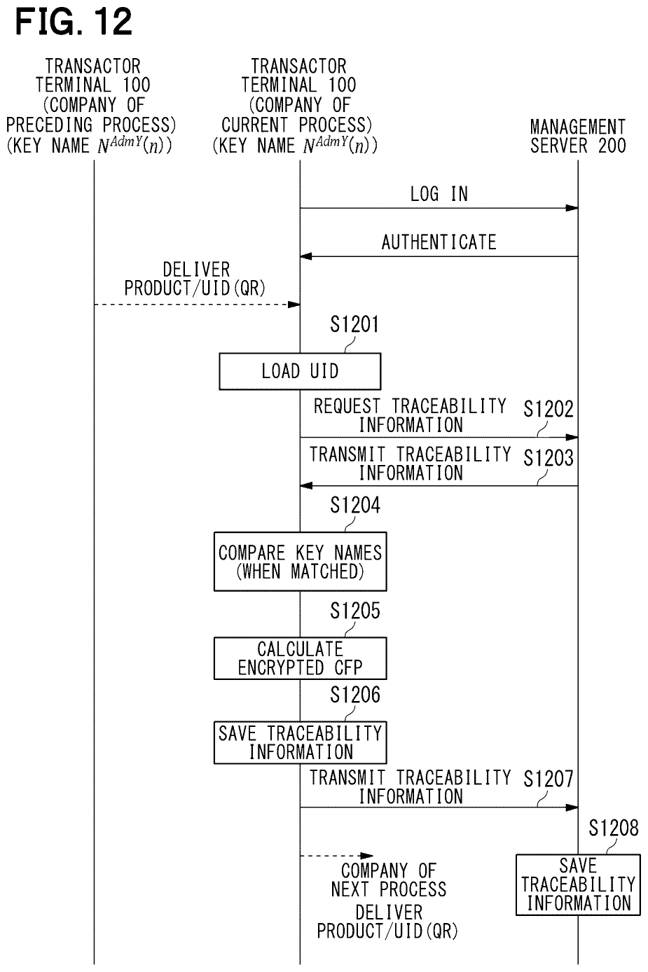

FIG. 12 is a flowchart illustrating details of the CFP calculation using the homomorphic encryption at a time of the addition/integration process in a case where there is a preceding process. The CFP calculation using the homomorphic encryption in a case where there is a preceding process at a time of the addition/integration process will be described with reference to FIG. 12. The processing is started when a transactor terminal 100 of a company of a current process of the key name N^{AdmY} (n) logs in the management server 200, and the management server 200 authenticates the login.

In S1201, the UID loading section 114 of the transactor terminal 100 in the company of the current process loads the UID attached to the product delivered from a company of a preceding process.

In S1202, the information acquisition section 116 transmits a request for sending the traceability information, the request using the UID loaded into the management server 200 as arguments.

In S1203, the information transmission section 212 transmits the traceability information corresponding to the loaded UID to the information acquisition section 116 of the transactor terminal 100.

In S1204, the information calculation section 118 compares the key name N^{AdmY} (n) of the company of the preceding process in the acquired traceability information with the key name N^{AdmY}(n) of the own company, and confirms whether the key names of both the companies match.

In S1205, the information calculation section 118 performs secure computation in which the CFP value x₂ related to the product of the own company is added to the encrypted information Enc (x₁, K_{pub}^{AdmY}(n)) in the acquired traceability information, and acquires encrypted information Enc (x₁+x₂,K_{pub}^{AdmY} (n)).

In S1206, the transactor terminal 100 records, in the traceability database DBT1, the traceability information including the UID, the CFP value x₂, the key name N^{AdmY} (n), encrypted CFP (Enc (x₂, K_{pub}^{AdmY} (n)) and Enc (x₁+x₂, K_{pub}^{AdmY} (n))), and the number of times of multiplication/division M^{AdmY} (n).

In S1207, the information transmission section 120 transmits the traceability information recorded in the traceability database DBT1 to the management server 200. Thereafter, a product with the UID is delivered to a company of a next process.

In S1208, the management server 200 records in the traceability database DBT2 the traceability information transmitted from the transactor terminal 100.

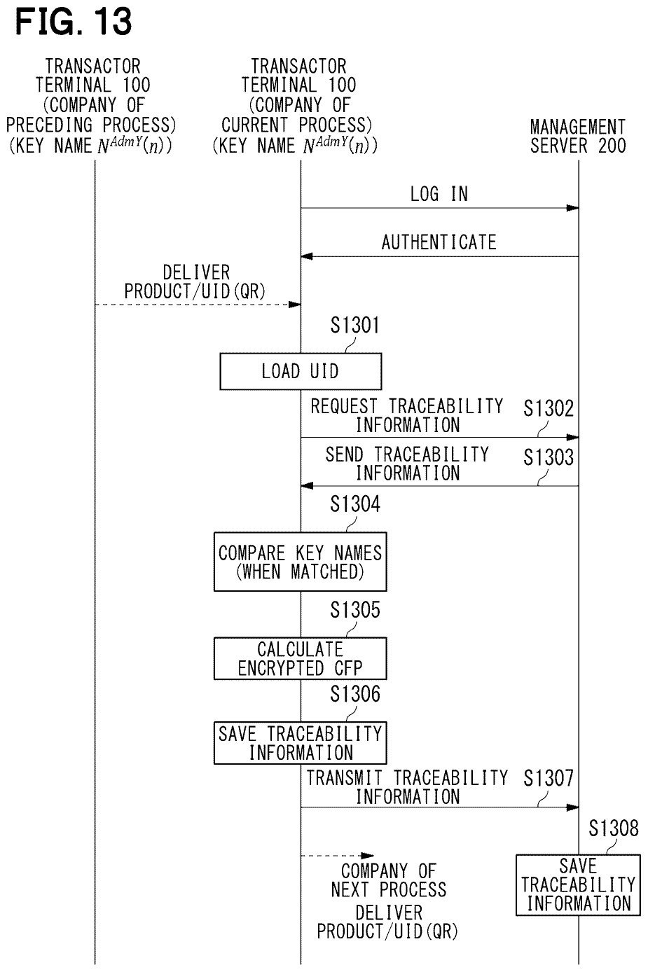

FIG. 13 is a flowchart illustrating details of the CFP calculation using the homomorphic encryption at a time of a branching process. The CFP calculation using the homomorphic encryption at a time of a branching process will be described with reference to FIG. 13. The processing is started when a transactor terminal 100 of a company of a current process of the key name N^{AdmY} (n) logs in the management server 200, and the management server 200 authenticates the login.

In S1301, the UID loading section 114 of the transactor terminal 100 in the company of the current process loads the UID attached to the product delivered from a company of a preceding process.

In S1302, the information acquisition section 116 transmits a request for sending the traceability information, the request using the UID loaded into the management server 200 as arguments.

In S1303, the information transmission section 212 transmits the traceability information corresponding to the loaded UID to the information acquisition section 116 of the transactor terminal 100.

In S1304, the information calculation section 118 compares the key name N^{AdmY} (n) of the company of the preceding process in the acquired traceability information with the key name N^{AdmY}(n) of the own company, and confirms whether the key names of both the companies match.

In S1305, the information calculation section 118 performs secure computation in which the CFP value x₂ related to the product of the own company is added to the encrypted information Enc (x₁, K_{pub}^{AdmY}(n)) in the acquired traceability information, and acquires encrypted information Enc (x₁+x₂,K_{pub}^{AdmY} (n)). The information calculation section 118 multiplies the encrypted information Enc (x₁+x₂, K_{pub}^{AdmY} (n)) by a branching ratio R, and adds 1 to the number of times of multiplication/division M^{AdmY} (n). Note that the multiplication by the branching ratio R is calculation processing in a case where the product corresponding to the branching ratio R is delivered to a company of a next process.

In S1306, the transactor terminal 100 records, in the traceability database DBT1, the traceability information including the UID, the CFP value x₂, the key name N^{AdmY} (n), encrypted CFP (Enc (x₂, K_{pub}^{AdmY} (n)) and Enc (x₁+x₂, K_{pub}^{AdmY} (n))), and the number of times of multiplication/division M^{AdmY} (n).

In S1307, the information transmission section 120 transmits the traceability information recorded in the traceability database DBT1 to the management server 200. Thereafter, a product with the UID is delivered to a company of a next process.

In S1308, the management server 200 records in the traceability database DBT2 the traceability information transmitted from the transactor terminal 100.

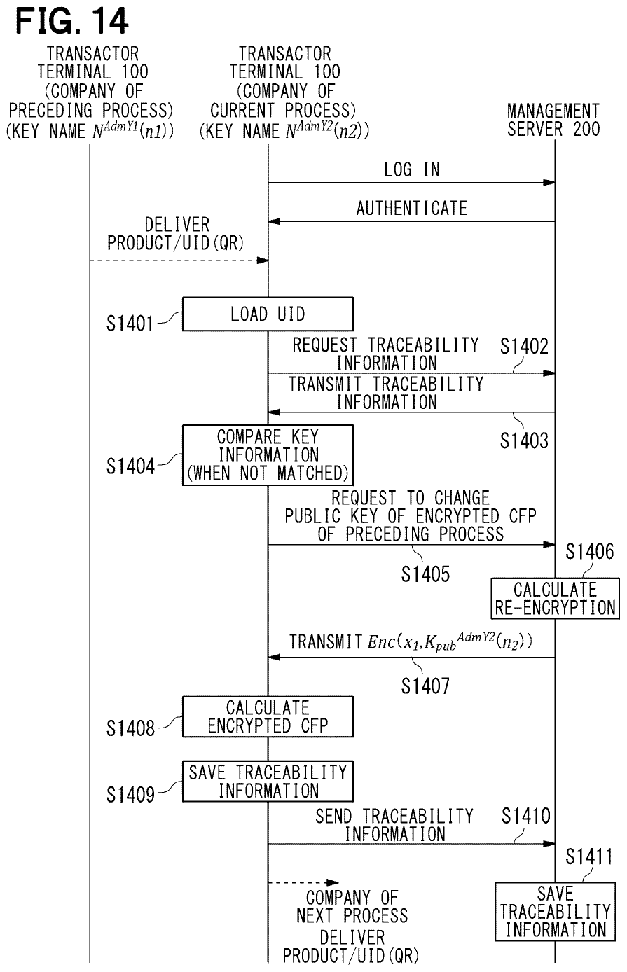

FIG. 14 is a flowchart illustrating details of the CFP calculation using the homomorphic encryption in a case where a public key for the preceding process is different. The CFP calculation using homomorphic encryption in a case where the public key for the company of the preceding process is different from a public key for the company of the current process will be described with reference to FIG. 14. The processing is started when a transactor terminal 100 of the company of the current process of a key name N^{AdmY2} (n₂) logs in the management server 200, and the management server 200 authenticates the login.

In S1401, the UID loading section 114 of the transactor terminal 100 in the company of the current process loads the UID attached to the product delivered from a company of a preceding process.

In S1402, the information acquisition section 116 transmits a request for sending the traceability information, the request using the UID loaded into the management server 200 as arguments.

In S1403, the information transmission section 212 transmits the traceability information corresponding to the loaded UID to the information acquisition section 116 of a transactor terminal 100.

In S1404, the information calculation section 118 compares a key name N^{AdmY1} (n₁) of the company of the preceding process in the acquired traceability information with the key name N^{AdmY2} (n₂) of the own company, and confirms whether the key names of both the companies do not match.

In a case where the key names of both the companies do not match, in S1405, the information calculation section 118 transmits a request for changing a public key K_{pub}^{AdmY1} (n₁) of encrypted information Enc (x₁, K_{pub}^{AdmY1} (n₁)) of the company of the preceding process. At this time, N^{AdmY1} (n₁), Enc (x₁, K_{pub}^{AdmY1} (n₁)), and N^{AdmY2} (n₂) are specified as arguments.

In S1406, the key acquisition section 216 searches the key database DBK for and acquires a private key Kₚᵣᵥ^{AdmY1} (n₁) corresponding to the key name N^{AdmY1} (n₁) and public key K_{pub}^{AdmY2} (n₂) corresponding to the key name N^{AdmY2} (n₂) in the change request. The decrypted information acquisition section 218 decrypts Enc (x₁, K_{pub}^{AdmY1} (n₁)) with the acquired private key Kₚᵣᵥ^{AdmY1} (n₁) to obtain x₁. The encryption processing section 220 calculates encrypted information Enc (x₁, K_{pub}^{AdmY2} (n₂)) by using x₁ and K_{pub}^{AdmY2} (n₂)).

In S1407, the provision section 222 transmits the encrypted information Enc (x₁, K_{pub}^{AdmY2} (n₂)) to the transactor terminal 100.

In S1408, the information calculation section 118 performs secure computation in which the measured CFP value x₂ related to the product of the own company is added to the encrypted information Enc (x₁, K_{pub}^{AdmY2} (n₂)), acquires encrypted information Enc (x₁+x₂, K_{pub}^{AdmY2} (n₂)), and updates the number of times of multiplication/division M^{AdmY2} (n₂) to 0.

In S1409, the transactor terminal 100 records, in the traceability database DBT1, the traceability information including the UID, the CFP value x₂, the key name N^{AdmY2} (n₂), encrypted CFP (Enc (x₂, K_{pub}^{AdmY2} (n₂)) and Enc (x₁+x₂, K_{pub}^{AdmY2} (n₂))), and the number of times of multiplication/division M^{AdmY2} (n₂).

In S1410, the information transmission section 120 transmits the traceability information recorded in the traceability database DBT1 to the management server 200. Thereafter, a product with the UID is delivered to a company of a next process.

In S1411, the management server 200 records in the traceability database DBT2 the traceability information transmitted from the transactor terminal 100.

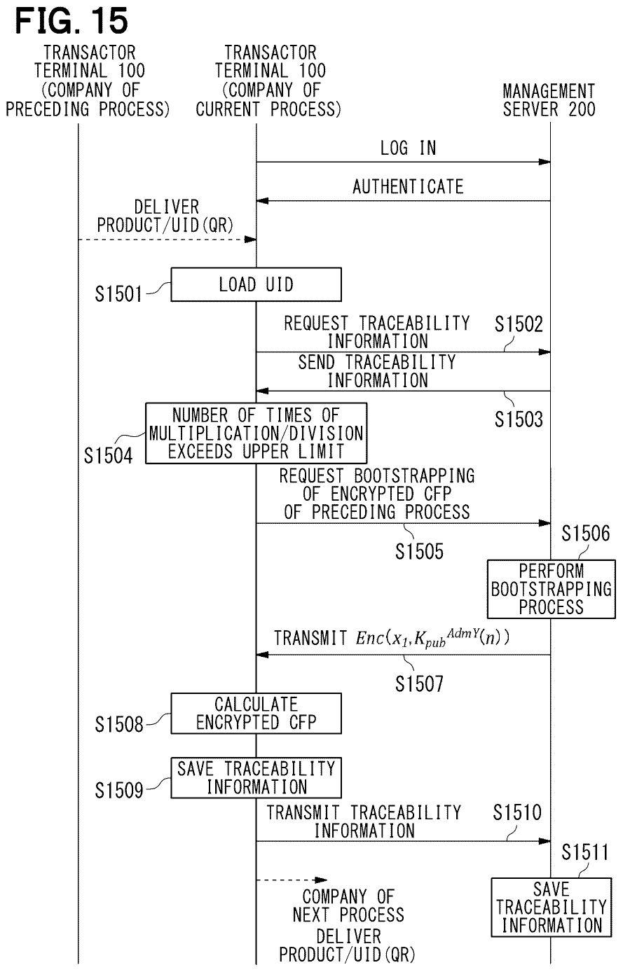

FIG. 15 is a flowchart illustrating details of the CFP calculation using the homomorphic encryption when the number of times of multiplication/division reaches an upper limit value. The CFP calculation using the homomorphic encryption when the number of times of multiplication/division reaches the upper limit value will be described with reference to FIG. 15. Note that the processing in FIG. 15 can be used in combination with the processing illustrated in FIGS. 11 to 14. The processing is started when a transactor terminal 100 of the company of the current process logs in the management server 200, and the management server 200 authenticates the login.

In S1501, the UID loading section 114 of the transactor terminal 100 in the company of the current process loads the UID attached to the product delivered from a company of a preceding process.

In S1502, the information acquisition section 116 transmits a request for sending the traceability information, the request using the UID loaded into the management server 200 as arguments.

In S1503, the information transmission section 212 transmits the traceability information corresponding to the loaded UID to the information acquisition section 116 of the transactor terminal 100.

In S1504, the information calculation section 118 checks whether the number of times of multiplication/division M^{AdmY} (n) in the acquired traceability information exceeds the upper limit value. Note that the upper limit value can be specified in advance from outside.

In a case where the number of times of multiplication/division M^{AdmY} (n) exceeds the upper limit value, in S1505, the information calculation section 118 of the transactor terminal 100 transmits a bootstrapping request of encrypted information Enc (x₁, K_{pub}^{AdmY} (n)) of the company of the preceding process to the management server 200. At this time, N^{AdmY} (n) and Enc (x₁, K_{pub}^{AdmY} (n)) are specified as arguments.

In S1506, the key acquisition section 216 searches the key database DBK for and acquires a private key Kₚᵣᵥ^{AdmY} (n) and public key K_{pub}^{AdmY} (n) corresponding to the key name N^{AdmY} (n) of the bootstrapping request. The decrypted information acquisition section 218 decrypts Enc (x₁, K_{pub}^{AdmY} (n)) with the acquired private key Kₚᵣᵥ^{AdmY} (n) to obtain x₁. The encryption processing section 220 calculates the encrypted information Enc (x₁, K_{pub}^{AdmY} (n)) by using x₁ and K_{pub}^{AdmY} (n).

In S1507, the provision section 222 transmits the encrypted information Enc (x₁, K_{pub}^{AdmY} (n)) to the transactor terminal 100.

In S1508, the information calculation section 118 performs secure computation in which the measured CFP value x₂ related to the product of the own company is added to the encrypted information Enc (x₁, K_{pub}^{AdmY} (n)), acquires encrypted information Enc (x₁+x₂, K_{pub}^{AdmY} (n)), and updates the number of times of multiplication/division M^{AdmY} (n) to 0.

In S1509, the transactor terminal 100 records, in the traceability database DBT1, the traceability information including the UID, the CFP value x₂, the key name N^{AdmY} (n), encrypted CFP (Enc (x₂, K_{pub}^{AdmY} (n)) and Enc (x₁+x₂, K_{pub}^{AdmY} (n))), and the number of times of multiplication/division M^{AdmY} (n).

In S1510, the information transmission section 120 transmits the traceability information recorded in the traceability database DBT1 to the management server 200. Thereafter, a product with the UID is delivered to a company of a next process.

In S1511, the management server 200 records in the traceability database DBT2 the traceability information transmitted from the transactor terminal 100.

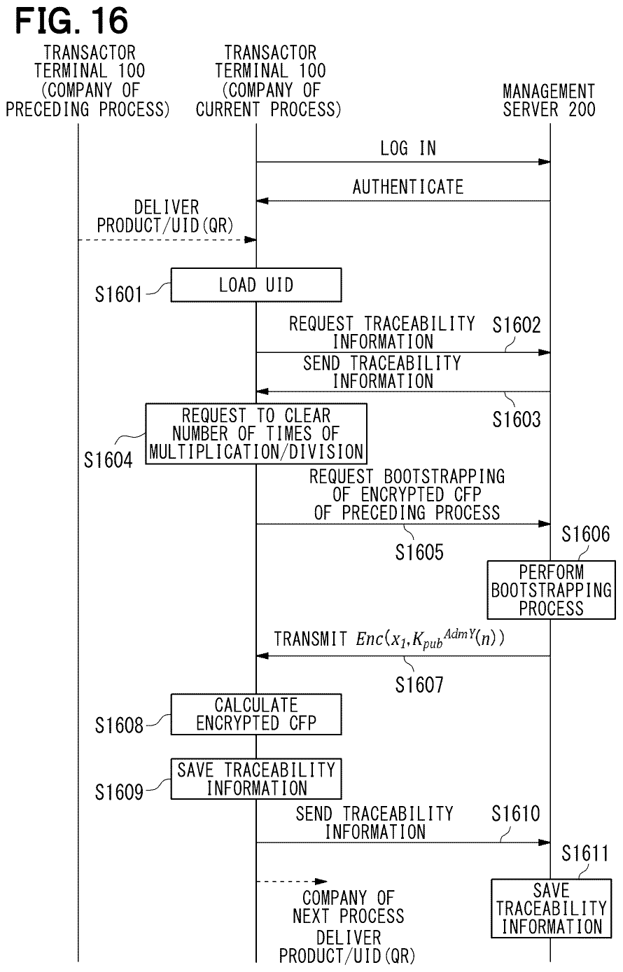

FIG. 16 is a flowchart illustrating details of the CFP calculation using the homomorphic encryption, when it is desired to clear the number of times of multiplication/division calculations. The CFP calculation using the homomorphic encryption when it is desired to clear the number of times of multiplication/division calculation will be described with reference to FIG. 16. Note that the processing in FIG. 16 can be used in combination with the processing illustrated in FIGS. 11 to 14. The processing is started when a transactor terminal 100 of the company of the current process logs in the management server 200, and the management server 200 authenticates the login.

In S1601, the UID loading section 114 of the transactor terminal 100 in the company of the current process loads the UID attached to the product delivered from a company of a preceding process.

In S1602, the information acquisition section 116 transmits a request for sending the traceability information, the request using the UID loaded into the management server 200 as arguments.

In S1603, the information transmission section 212 transmits the traceability information corresponding to the loaded UID to the information acquisition section 116 of the transactor terminal 100.

In S1604, the transactor of the transactor terminal 100 inputs, to the transactor terminal 100, a clear request for clearing the number of times of multiplication/division M^{AdmY} (n) in the acquired traceability information.

In S1605, on the basis of the clear request, the information calculation section 118 of the transactor terminal 100 transmits a bootstrapping request of encrypted information Enc (x₁, K_{pub}^{AdmY} (n)) of the company of the preceding process to the management server 200. At this time, N^{AdmY} (n) and Enc (x₁, K_{pub}^{AdmY} (n)) are specified as arguments.

In S1606, the key acquisition section 216 searches the key database DBK for and acquires a private key Kₚᵣᵥ^{AdmY} (n) and public key K_{pub}^{AdmY} (n) corresponding to the key name N^{AdmY} (n) of the bootstrapping request. The decrypted information acquisition section 218 decrypts Enc (x₁, K_{pub}^{AdmY} (n)) with the acquired private key Kₚᵣᵥ^{AdmY} (n) to obtain x₁. The encryption processing section 220 calculates the encrypted information Enc (x₁, K_{pub}^{AdmY} (n)) by using x₁ and K_{pub}^{AdmY} (n).

In S1607, the provision section 222 transmits the encrypted information Enc (x₁, K_{pub}^{AdmY} (n)) to the transactor terminal 100.

In S1608, the information calculation section 118 performs secure computation in which the measured CFP value x₂ related to the product of the own company is added to the encrypted information Enc (x₁, K_{pub}^{AdmY} (n)), acquires encrypted information Enc (x₁+x₂, K_{pub}^{AdmY} (n)), and updates the number of times of multiplication/division M^{AdmY} (n) to 0.

In S1609, the transactor terminal 100 records, in the traceability database DBT1, the traceability information including the UID, the CFP value x₂, the key name N^{AdmY} (n), encrypted CFP (Enc (x₂, K_{pub}^{AdmY} (n)) and Enc (x₁+x₂, K_{pub}^{AdmY} (n))), and the number of times of multiplication/division M^{AdmY} (n).

In S1610, the information transmission section 120 transmits the traceability information recorded in the traceability database DBT1 to the management server 200. Thereafter, a product with the UID is delivered to a company of a next process.

In S1611, the management server 200 records in the traceability database DBT2 the traceability information transmitted from the transactor terminal 100.

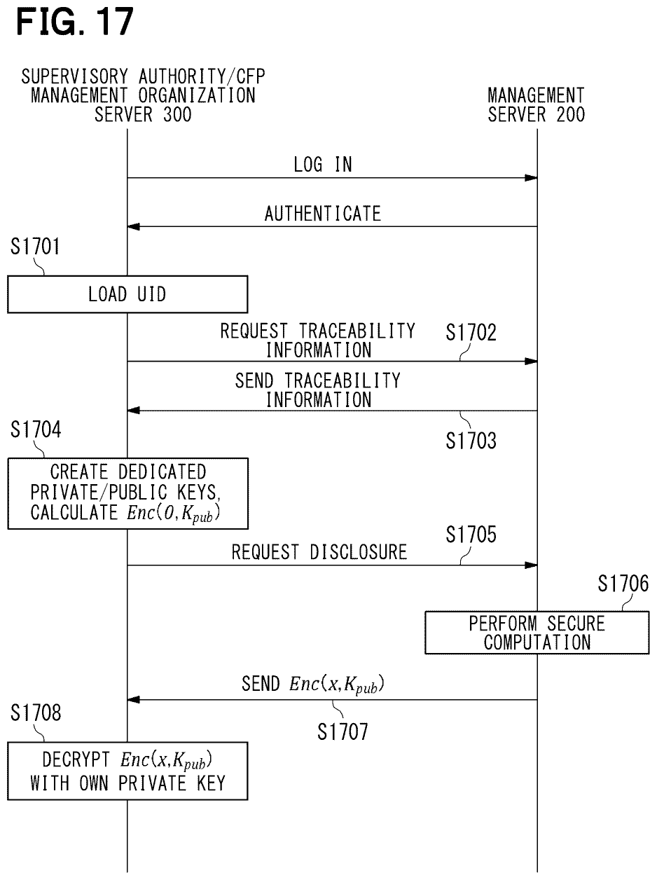

FIG. 17 is a flowchart illustrating details of processing in a case where there is a request for disclosure of a CFP value from a supervisory authority/CFP management organization. With reference to FIG. 17, the processing in a case where there is a request for disclosure of an actual value of a CFP from the supervisory authority/CFP management organization will be described. The processing is started when the supervisory authority/CFP management organization server 300 logs in the management server 200, and the management server 200 authenticates the login.

In S1701, the UID loading section 312 of the supervisory authority/CFP management organization server 300 loads the UID attached to a product whose CFP value is to be disclosed.

In S1702, the information acquisition section 314 transmits a request for sending the traceability information, the request using the UID loaded into the management server 200 as arguments.

In S1703, the information transmission section 212 transmits the traceability information corresponding to the loaded UID to the information acquisition section 314 of the supervisory authority/CFP management organization server 300.

In S1704, the dedicated key generation section 320 of the supervisory authority/CFP management organization server 300 creates and prepares a set of the dedicated private key Kₚᵣᵥ and the public key K_{pub}. The information calculation section 316 encrypts the numerical value 0 by using a dedicated public key K_{pub} and calculates encrypted information Enc (0, K_{pub}).

In S1705, the sending request transmission section 322 transmits the request for disclosure of the actual value of the CFP to the management server 200. At this time, N^{Adm} (n), Enc (x, K_{pub}^{Adm} (n)), and Enc (0, K_{pub}) are specified as arguments. Note that Enc (x, K_{pub}^{Adm} (n)) is an encrypted CFP value to be disclosed in the acquired traceability information.

In S1706, the key acquisition section 216 searches the key database DBK for and acquires a private key Kₚᵣᵥ^{Adm} (n) corresponding to a key name N^{Adm} (n) specified as an argument. The decrypted information acquisition section 218 decrypts Enc (x, K_{pub}^{Adm} (n)) with the acquired private key Kₚᵣᵥ^{Adm} (n) to obtain x. The encryption processing section 220 calculates encrypted information Enc (x, K_{pub}) with secure computation in which Enc (0, K_{pub}) is added to x.

In S1707, the provision section 222 transmits the encrypted information Enc (x, K_{pub}) to the supervisory authority/CFP management organization server 300.

In S1708, the information calculation section 316 decrypts the encrypted information Enc (x, K_{pub}) by using the dedicated private key Kₚᵣᵥ to acquire x.

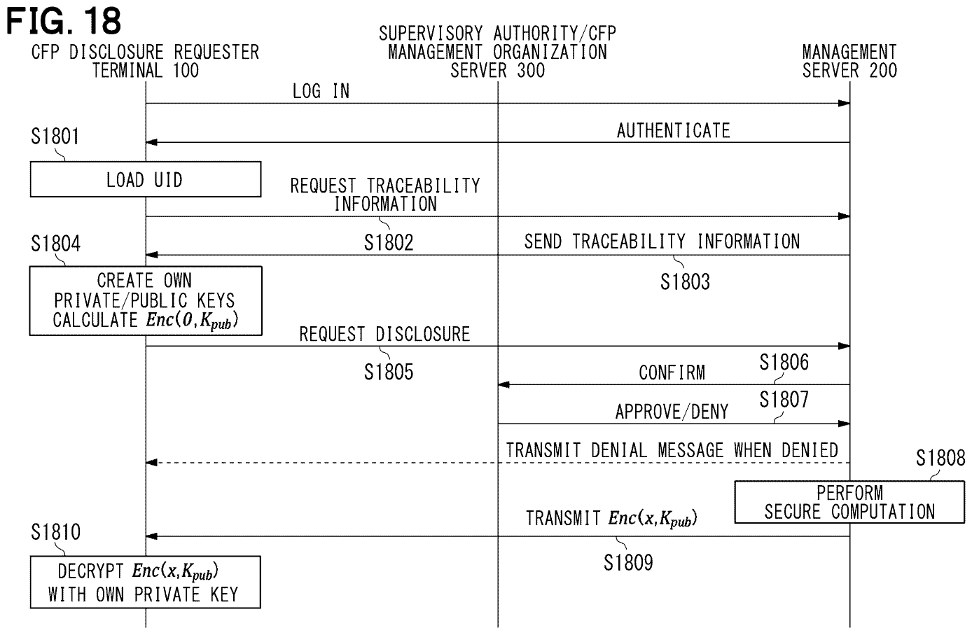

FIG. 18 is a flowchart illustrating details of processing in a case where there is a request for disclosure of a CFP value from an entity other than the supervisory authority/CFP management organization. With reference to FIG. 18, the processing in a case where there is a request for disclosure of an actual value of a CFP from a disclosure requester other than the supervisory authority/CFP management organization will be described. The disclosure requester (hereinafter, CFP disclosure requester) other than the supervisory authority/CFP management organization is, for example, a consumer, an employee of a company, or the like. The processing is started when the CFP disclosure requester logs in the management server 200 with a terminal used by the CFP disclosure requester, and the management server 200 authenticates the login. Here, the terminal used by the CFP disclosure requester is, for example, an information processing device such as a smartphone, a tablet terminal, or a personal computer, and has a configuration similar to that of the transactor terminal 100. Therefore, hereinafter, the terminal used by the CFP disclosure requester will be described as the transactor terminal 100.

In S1801, the UID loading section 114 of the transactor terminal 100 loads the UID attached to a product whose CFP value is to be disclosed.

In S1802, the information acquisition section 116 transmits a request for sending the traceability information, the request using the UID loaded into the management server 200 as arguments.

In S1803, the information transmission section 120 transmits the traceability information corresponding to the loaded UID to the information acquisition section 116 of the transactor terminal 100.

In S1804, a dedicated key generation section 122 of the transactor terminal 100 creates and prepares a dedicated set of a private key Kₚᵣᵥ and a public key K_{pub}. The information calculation section 118 encrypts the numerical value 0 by using a dedicated public key K_{pub} and calculates encrypted information Enc (0, K_{pub}).

In S1805, the sending request transmission section 124 transmits the request for disclosure of the actual value of the CFP to the management server 200. At this time, N^{Adm} (n), Enc (x, K_{pub}^{Adm} (n)), and Enc (0, K_{pub}) are specified as arguments. Note that Enc (x, K_{pub}^{Adm} (n)) is an encrypted CFP value to be disclosed in the acquired traceability information.

In S1806, the management server 200 transmits a message to the supervisory authority/CFP management organization server 300, notifies that there is a request for disclosure of a CFP value from the CFP disclosure requester, and confirms whether the CFP value may be disclosed.

In S1807, the supervisory authority/CFP management organization server 300 approves or denies the disclosure request. In a case where the disclosure request is denied, the supervisory authority/CFP management organization server 300 transmits a denial message to the transactor terminal 100. In a case where the disclosure request is approved, the supervisory authority/CFP management organization server 300 transmits the approval to the management server 200, and the flow proceeds to S1808.

In S1808, the key acquisition section 216 searches the key database DBK for and acquires a private key Kₚᵣᵥ^{Adm} (n) corresponding to a key name N^{Adm} (n) specified as an argument. The decrypted information acquisition section 218 decrypts Enc (x, K_{pub}^{Adm} (n)) with the acquired private key Kₚᵣᵥ^{Adm} (n) to obtain x. The encryption processing section 220 calculates encrypted information Enc (x, K_{pub}) with secure computation in which Enc (0, K_{pub}) is added to x.

In S1809, the provision section 222 transmits the encrypted information Enc (x, K_{pub}) to the transactor terminal 100.

In S1810, the information calculation section 118 decrypts the encrypted information Enc (x, K_{pub}) by using the dedicated private key Kₚᵣᵥ to acquire x.

### Other Embodiments

Embodiments of the present disclosure have been described above. The present disclosure should not be limited to the above embodiments and may be implemented in various other embodiments and combinations without departing from the scope of the present disclosure.

In the above embodiments, the CFP value of each process is used as the item-related information. However, information of an amount of power usage or energy resource usage related to processing performed on an item in each process may be used as the item-related information. Type information indicating a power generation method such as, for example, hydraulic power, thermal power, wind power, geothermal power, nuclear power, or solar power is associated with the information of the amount of power usage. Similarly, the information of the amount of energy resource usage is associated with information indicating a type of fuel such as, for example, crude oil, coal, natural gas, or hydrogen. As the item-related information, an amount of rare metal usage or an amount of generation of specific hazardous substances to be regulated can also be used.

As in the example described above, the supply chain management system 1 according to the present disclosure is particularly suitable for information legally required to be recorded.

In the above embodiments, each of the functions provided by the transactor terminal 100, the management server 200, and the supervisory authority/CFP management organization server 300 can be provided by software and hardware for executing the software, software alone, hardware alone, or a combination thereof. In a case where such functions are provided by an electronic circuit as hardware, each of the functions can also be provided by a digital circuit including a large number of logic circuits or an analog circuit.

Although the present disclosure has been described in accordance with embodiments, it is understood that the present disclosure is not limited to such embodiments or structures. The present disclosure also encompasses various modifications and equivalents within the scope of the invention. In addition, various combinations and forms, as well as other combinations and forms including only one element, more than one element, or fewer elements, are also within the scope and spirit of the present disclosure.

What is claimed is:

1. An information processing device that manages item-related information related to an item handled by a plurality of transactors that constitutes a supply chain, the information processing device comprising
a database that stores each of a plurality of sets of a private key based on homomorphic encryption and a public key corresponding to the private key in association with a key name, and
at least one of (i) a circuit and (ii) a processor with a memory storing computer program code executable by the processor, the at least one of the circuit and the processor configured to cause the information processing device to:
acquire, from a transactor terminal of a transactor, encrypted information obtained by encrypting item-related information by using a public key, and a key name of the public key used to encrypt the item-related information;
acquire, from the database, a private key corresponding to the key name;
acquire decrypted information by decrypting, with the private key, the encrypted information;
acquire re-encrypted information by encrypting the decrypted information; and
provide the re-encrypted information encrypted to the transactor terminal,
wherein
the at least one of the circuit and the processor is further configured to acquire, from the transactor terminal of the transactor, encrypted information encrypted by using a public key that is a public key based on homomorphic encryption and is a public key different from a public key managed in the database, and
the at least one of the circuit and the processor is configured to acquire the re-encrypted information from secure computation using the encrypted information and the decrypted information.

2. The information processing device according to claim 1, wherein
the at least one of the circuit and the processor is configured to acquire, from the transactor terminal, first encrypted information obtained by encrypting first item-related information by using a first public key, and a first key name of the first public key used to encrypt the first item-related information, and second encrypted information obtained by encrypting second item-related information by using a second public key, and a second key name of the second public key used to encrypt the second item-related information,
the at least one of the circuit and the processor is configured to acquire, from the database, a first private key corresponding to the first key name and a second private key corresponding to the second key name,
the at least one of the circuit and the processor is configured to acquire first decrypted information by decrypting, with the first private key, the first encrypted information, and acquires second decrypted information by decrypting, with the second private key, the second encrypted information, and
the at least one of the circuit and the processor is configured to encrypt a calculation result obtained by using the first decrypted information and the second decrypted information, and acquires the re-encrypted information.

3. The information processing device according to claim 2, wherein
the at least one of the circuit and the processor is further configured to acquire, from the transactor terminal of the transactor, a third key name that is different from the first key name and the second key name,
the at least one of the circuit and the processor is configured to acquire, from the database, a public key corresponding to the third key name, and
the at least one of the circuit and the processor is configured to encrypt the calculation result with a public key corresponding to the third key name, and acquires the re-encrypted information.

4. The information processing device according to claim 1, wherein
the at least one of the circuit and the processor is configured to acquire, from the transactor terminal of the transactor, first encrypted information obtained by encrypting first item-related information by using a first public key, a first key name of the first public key used to encrypt the first item-related information, and a third key name that is different from the first key name,
the at least one of the circuit and the processor is configured to acquire, from the database, a first private key corresponding to the first key name,
the at least one of the circuit and the processor is configured to acquire first decrypted information by decrypting, with the first private key, the first encrypted information, and
the at least one of the circuit and the processor is configured to encrypt first decrypted information with a public key corresponding to the third key name, and acquires the re-encrypted information.

5. The information processing device according to claim 1, wherein
the at least one of the circuit and the processor is configured to acquire, from the database, a public key corresponding to the key name, and
the at least one of the circuit and the processor is configured to encrypt the decrypted information with the public key and acquires the re-encrypted information.

6. The information processing device according to claim 1, wherein
the item-related information includes information of an emission amount of a greenhouse gas.

7. The information processing device according to claim 1, wherein
the item-related information includes information of an amount of usage by type of power or energy resource.

8. An information processing system comprising
an information processing device that manages item-related information related to an item handled by a plurality of transactors that constitutes a supply chain, and
a transactor terminal of a transactor,
wherein
the information processing device includes
a database that stores each of a plurality of sets of a private key based on homomorphic encryption and a public key corresponding to the private key in association with a key name, and
at least one of (i) a circuit and (ii) a processor with a memory storing computer program code executable by the processor, the at least one of the circuit and the processor configured to cause the information processing device to:
acquire, from the transactor terminal of the transactor, encrypted information obtained by encrypting item-related information by using a public key, and a key name of the public key used to encrypt the item-related information,
acquire, from the database, a private key corresponding to the key name,
acquire decrypted information by decrypting, with the private key, the encrypted information,
acquire re-encrypted information by encrypting the decrypted information, and
provide the re-encrypted information encrypted, and
the transactor terminal includes a secure computation section that generates encrypted information with secure computation using the re-encrypted information and plaintext information of item-related information.

9. The information processing system according to claim 8, wherein
the transactor terminal includes a code generation section that generates a code indicating encrypted information generated by the secure computation.

10. The information processing system according to claim 8, wherein
the transactor terminal includes a sending request transmission section that transmits, to the information processing device, a request for sending encrypted information of a predetermined value, and
the information processing device is configured to encrypt the predetermined value to generate encrypted predetermined value information, and to provide the encrypted predetermined value information to the transactor terminal.

11. The information processing system according to claim 10, wherein
the secure computation section of the transactor terminal generates encrypted information with secure computation using the encrypted predetermined value information and plaintext information of item-related information.

12. The information processing system according to claim 11, wherein
the transactor terminal further includes a code generation section that generates a code indicating encrypted information obtained by the secure computation.

13. An information processing method for managing item-related information related to an item handled by a plurality of transactors that constitutes a supply chain, the information processing method comprising
recording, in a database, each of a plurality of sets of a private key based on homomorphic encryption and a public key corresponding to the private key in association with a key name,
acquiring, from a transactor terminal of a transactor, encrypted information obtained by encrypting item-related information by using a public key, and a key name of the public key used to encrypt the item-related information,
acquiring, from the database, a private key corresponding to the key name,
acquiring decrypted information by decrypting, with the private key, encrypted information,
acquiring re-encrypted information by encrypting the decrypted information, and
providing the re-encrypted information to the transactor terminal,
wherein
in acquiring the encrypted information, encrypted information encrypted by using a public key that is a public key based on homomorphic encryption and is a public key different from a public key managed in the database is further acquired from the transactor terminal of the transactor, and
in acquiring the re-encrypted information, the re-encrypted information is acquired from secure computation using the encrypted information and the decrypted information.
